(19) United States
(12) Patent Application Publication
(10) Pub. No.: US 2004/0250462 A1
(43) Pub. Date: Dec. 16, 2004

(54) Cover for fishing lure on fishing rod

(76) Inventor: Jesse B. Trebil, Atwater, MN (US)

Correspondence Address: Richard C. Litman, LITMAN LAW OFFICES, LTD., P.O. Box 15035, Arlington, VA, 22215, US

(21) Appl. No.: 10/457,531

(22) Filed: Jun. 10, 2003

(51) Int. Cl. A01K 87/00

(52) U.S. Cl. 43/25.2

(57) ABSTRACT

A cover for a lure on a fishing rod includes first and second housing elements, each having a substantially semi-cylindrical surface; first and second opposing end walls, each of the end walls has a semi-circular cutout; a hinging element; and a latching device. The first and second housing elements being coupled together via the hinging element and the latching device, so as to form a substantially cylindrical interior chamber when the cover is closed thereby enclosing a fishing lure when the cover is folded around a fishing rod and latched. The holes in the end walls of the cover may be eccentrically defined in the end walls.

### BACKGROUND OF THE INVENTION

1. Field of the Invention

The present invention relates generally to covers for fishing lures and fishhooks when disposed on fishing rods.

2. Description of the Related Art

As anyone who has handled a fishing rod will appreciate, the hook and lure at the end of the line when not in use presents a potential safety hazard. Most people engage the hook with one of the rod loops and tighten the line to prevent the hook from releasing from the rod. This is only marginally effective because the hook is not fully covered and further the hook has a tendency to release from the loop. Furthermore, many lures have a series of hooks which cannot be effectively hidden by the rod in this manner. Different proposals have been made to overcome the above problem. Examples of these proposals are discussed herein below.

U.S. patent application Ser. No. 2002/0073606 A1, published Jun. 20, 2002 to Mameamskum, discusses a one-piece cover for a fishing lure used during fishing operations. The cover provides an enhancement to colors of the lure. In addition, the cover provides hydro- and aerodynamic structure to an older or used lure.

U.S. Pat. No. 512,746, issued Jan. 16, 1894 to Payson, discusses a guard for fishhooks to prevent the hook from being snagged on weeds, brush or debris while the fishhook is being drawn through the water while fishing.

U.S. Pat. No. 2,586,073, issued Feb. 19, 1952 to McKee, discusses an appliance for use in releasing snagged fish plugs or spoons.

U.S. Pat. No. 4,222,193, issued Sep. 16, 1980 to Beck, shows a tubular case for a fishing rod that is formed from braided or pseudo-braided plastic filaments of an open, expandable weave, one end of the case being closed and provided with a loop member for hanging it hereof. The opposite end of the tubular case preferably has a flared opening to facilitate the insertion therein of the small, upper end of a fishing rod and its line guide. As the rod is forced into the sleeve, the sleeve expands so as to conform generally to the shape of the rod and its protuberances, i.e., line guides, bobbers, sinkers, and the like.

U.S. Pat. No. 4,916,852, issued Apr. 17, 1990 to Zebleckis, discusses a protective cover for a fishing rod which includes a conformable, expandable, elongated and woven plastic sleeve having an open end and a closed end which has been fused together in the flat position. A tag is folded over the top end and a grommet-like member inserted through the top end and tag to form an eyelet for hanging the cover and rod encased therein. A method of forming the protective fishing rod cover is disclosed. This type of cover is suitable for covering a rod to be used when selected for use and for storing said rod. A hook is secured to the tag so as to grasp the cover and permit storage in a rolled and closed configuration.

U.S. Pat. No. 5,277,306, issued Jan. 11, 1994 to Sargent, discusses a fishing tackle covers that are useful separately or together. The fishing rod cover has a see-through pliable perforate sleeve with a closure flap. A fishing rod and reel assembly can be inserted into and removed from it repeatedly. Fishing rods can be protected from contact with other rods without the need for disassembly of rod, reel, line and even attached lure or hook. The rod cover keeps fishing lines from tangling, especially when used with other covers of the invention; it permits quick visual identification and rapid removal of the assembled rod combination ready for fishing; it facilitates drying out of any wet equipment it may cover, and it may be rolled up and kept that way easily for convenient stowage. For example, the rod cover may be made to primarily incorporate a fiberglass screen in its sleeve and closure flap. As well, fishing hook/lure cover is a purse having a panel set. The purse generally has insertion and extraction ends, with a repeatedly sealable border, and it is non-damaging to rod, line and hook and/or lure. The hook/lure cover may be transparent. For example, the hook/lure cover may be made to primarily incorporate clear vinyl in its panel set.

U.S. Pat. No. 5,293,711, issued Mar. 15, 1994 to Robinson, discusses an elongate flexible tube having an entrance opening that is arranged to receive a fishing rod therewithin, with the entrance opening including a drawstring to effect securement of the fishing rod cover to the associated fishing rod.

U.S. Pat. No. 5,430,969, issued Jul. 11, 1995 to Taylor et al., discusses a fish hook and lure cover attachable directly to a fishing rod. The cover comprises a housing which contains the hook and lure with the housing having first and second ends, being opened at the first end to admit the hook and lure and having a fishing line receiving slot along the upper surface of the housing from the first end to the second end of the housing.

U.S. Pat. No. 5,836,103, issued Nov. 17, 1998 to Taylor, discusses a new fishing rod and tackle carrier system for providing a fisherman with a safer and more efficient means of storing and carrying his fishing rods, and also providing a tackle box that when attached to the storage tubes will provide the fisherman with a convenient package to take on a fishing trip.

U.S. Pat. No. 5,992,082, issued Nov. 30, 1999 to Barefoot, discusses an elongated hollow fishing lure pouch made of a relatively flexible elastomeric material having high memory retention and that is operable by squeezing the ends of the pouch to open a slit extending lengthwise of the pouch for placement of a lure into and removal of the lure from the pouch.

U.S. Pat. No. 6,085,455, issued Jul. 11, 2000 to Bracken, discusses a protective housing for a fishing pole. The protective housing includes first and second housing elements, each having a substantially planar surface, first and second opposing longitudinal walls and first and second opposing end walls extending from the substantially planar surface, the first longitudinal walls of the first and second housing elements being hingedly coupled together so as to form an interior chamber when the protective housing is in a closed position. In the closed position, the second longitudinal wall and the first and second end wall of the first housing element are in mutual contact with the second longitudinal wall and the first and second end wall of the second housing element, respectively. The second longitudinal walls of each of the first and second housing elements have cooperating latch elements for securing the protective housing in the closed position and the first and second end walls of each of the first and second housing elements have a semicircular cutout arranged so as to form a circular opening in each end of the protective housing when in the closed position. The protective housing is mountable on the fishing pole by placing the rod longitudinally across one of the first and second housing elements, within the cutouts in the end walls of the housing element, and pivoting the first and second housing elements together until the protective housing is in the closed position with the rod being disposed within the circular openings at each end of the protective housing. The protective housing further includes at least one storage compartment integrally formed with the first housing element, the storage compartment being constructed and arranged so as to be located within the interior chamber when the protective housing is in the closed position.

U.S. Pat. No. 6,408,564 B1, issued Jun. 25, 2002 to Murphy, discusses a fishing rod cover system for protecting the fishing rod from damage and for reducing entanglement of the fishing line during nonuse.

French Patent Document No. 1,419,803published Oct. 2, 1964 describes a flexible case for a fishing rod and reel combo, that simultaneously serves as a haversack or ‘fanniepack’.

W.I.P.O. Patent Document No. WO 92/10931 A1 published Jul. 9, 1992 describes a box for lures and a modular attachment device for transporting fishing rods.

None of the above inventions and patents, taken either singly or in combination, is seen to describe the instant invention as claimed. Thus a cover for fishing lures on fishing rods solving the aforementioned problems is desired.

### SUMMARY OF THE INVENTION

The cover for a fishing lure on a fishing rod will cover a lure on a fishing rod to keep the lure from snagging things when one is not fishing. The cover is made of lightweight, yet durable material (e.g., plastic) and is inexpensive. It could also be made in a variety of sizes, for different sized fishing lures. The present invention provides a protective housing for a fishing pole which both encloses a hook which is attached to a line of the fishing pole to prevent the hook from becoming entangled with other fishing pole lines, or being snagged in clothing or upholstery and causing injuries, and which also provides a separate and secure storage compartment for storing fishing tackle.

According to the invention, a protective housing for a fishing pole is disclosed. The protective housing, preferably, is substantially cylindrical. The protective housing includes first and second housing elements, each preferably having a substantially semicylindrical shape. The housing shape may be selected from a range of shapes from cylindrical to spherical. Each of the first and second elements is a mirror image of the other. Each semi-cylindrical surface includes first and second opposing end walls. The first and second housing elements are hinged together so as to form an interior chamber when the protective housing is in a closed position.

In the closed position, the first and second end walls of the first housing element are in mutual contact with the first and second end walls of the second housing element, respectively, forming the substantially cylindrical protective housing. Opposite the hinge coupling of the first and second housing elements, cooperating latch elements are provided for releasably and selectively maintaining the protective housing in the closed position.

The first and second end walls of each of the first and second housing elements have a semi-circular cutout arranged so as to form a circular opening in each end of the protective housing when in the closed position. The protective housing is mountable on the fishing pole by placing the rod longitudinally across one of the first and second housing elements, within the cutouts in the end walls of the housing element, and pivoting the first and second housing elements together until the protective housing is in the closed position with the rod being disposed within the circular openings at each end of the protective housing. Each of the semi-circular cutouts have a thickened or rounded edge so as to prevent kinking of the line on the fishing rod when the cover is in the closed position around the rod and lure.

Accordingly, it is a principal object of the invention to provide a cover for a fishing lure on a fishing rod which forms a protective housing to prevent damage to the lure, as well as preventing the lure or fish hook from becoming entangled with other lines, or from causing accidental puncture wounds.

It is another object of the invention to provide a protective housing for attachment to a fishing rod around a lure and fish hook that is operable using a single hand.

It is a further object of the invention to provide a protective housing attachable to a fishing rod to enclose a lure and fishhook which has a unitary form.

Still another object of the invention is to provide a protective housing that is eccentrically mounted on a fishing rod to cover a lure and fish hook, so that the lure is enclosed on one side of the rod while the housing has no wasted or empty space on the other side of the rod.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a cover for a fishing lure on a fishing rod according to the present invention, the pole being shown in phantom).

FIG. 2A is a perspective view of the cover of the present invention.

FIG. 2B is a perspective view of the cover of the present invention as seen from the end opposite FIG. 2A.

FIG. 3 is a section view along the lines 3-3 of FIG. 2A.

FIG. 4 is a perspective view of the exterior of the cover of the present invention with the cover opened.

FIG. 5 is a perspective view of the interior of the cover of the present invention with-the cover opened.

Similar reference characters denote corresponding features consistently throughout the attached drawings.

### DETAILED DESCRIPTION OF THE PREFERRED EMBODIMENT

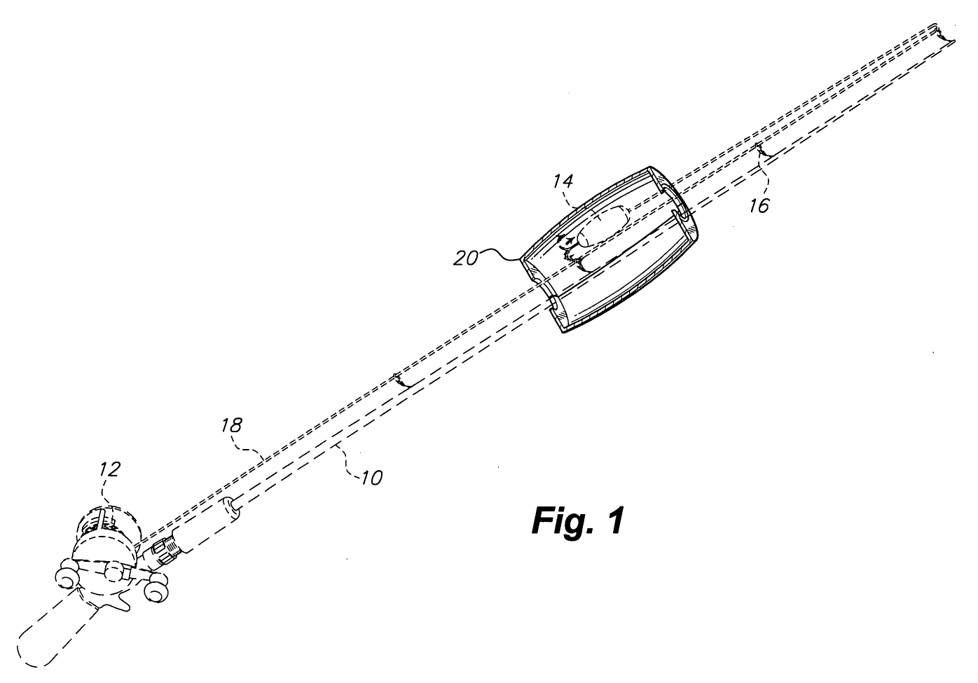

Referring now to the drawings, the cover for a fishing lure on a fishing rod of the present invention will be described. Shown in FIG. 1 is the cover 20 (also referred to herein as a protective housing 20) installed on a fishing pole 10 (the pole 10 being shown in phantom) which includes a reel 12, a number of eyelets 16 (only one being shown in FIG. 1) and a fishing line 18. The fishing line 18 is supplied from the reel 12, is threaded through the eyelets 16 and has a lure and hook 14 tied to one end. It will be understood that any type of lure, hook or jig 14 may be attached to the fishing line and still be used with the present invention. However, for simplicity, a simple lure is shown in the drawings for use with the present invention.

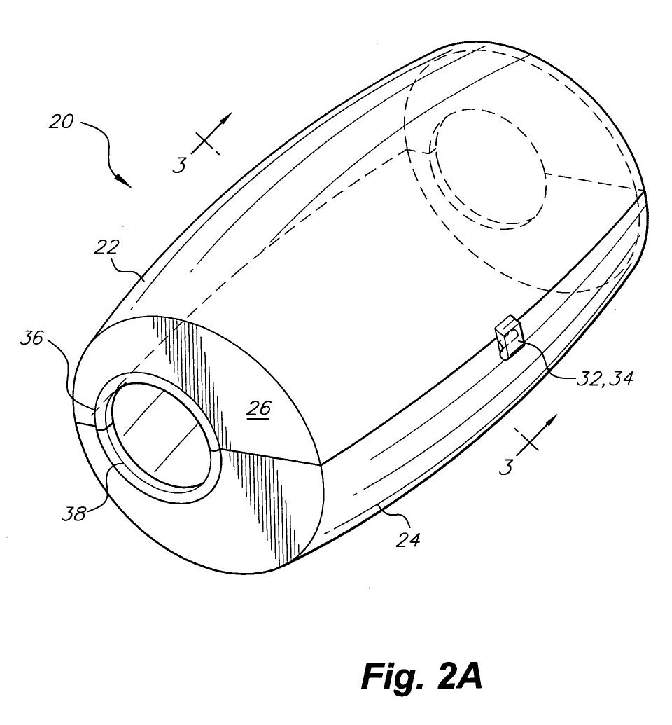

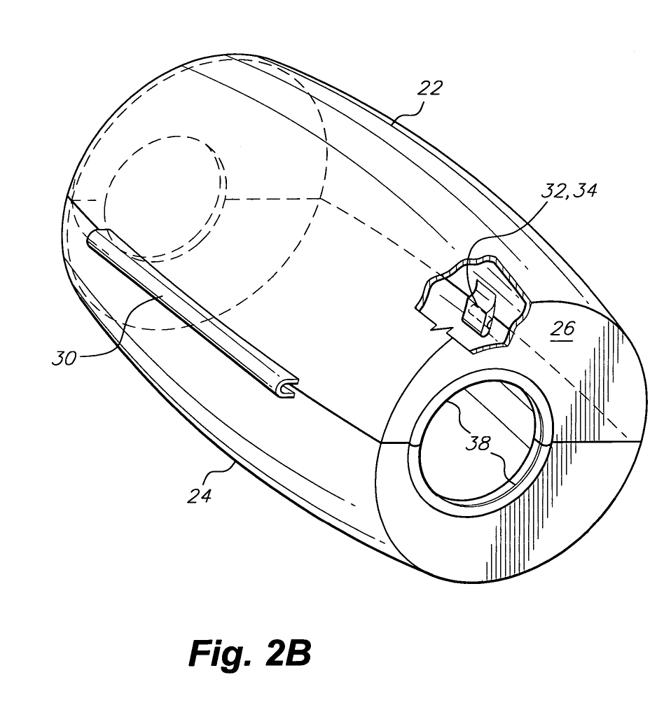

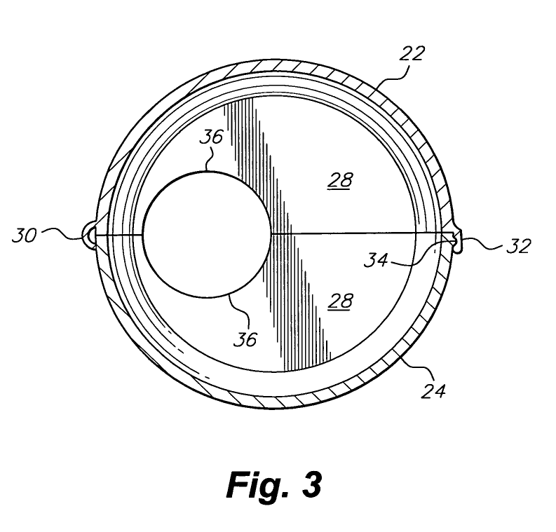

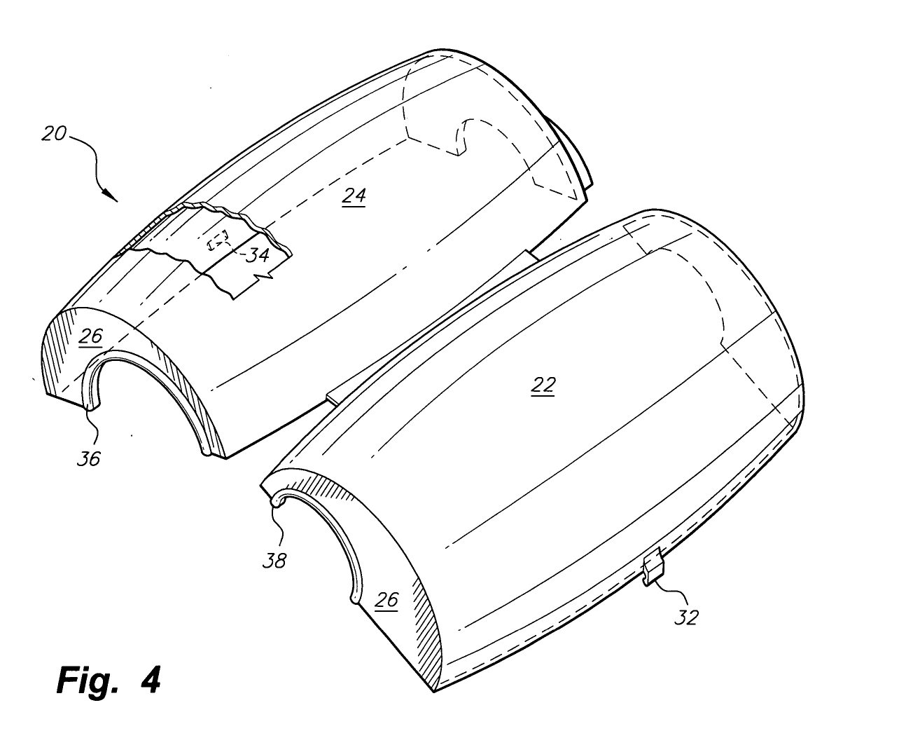

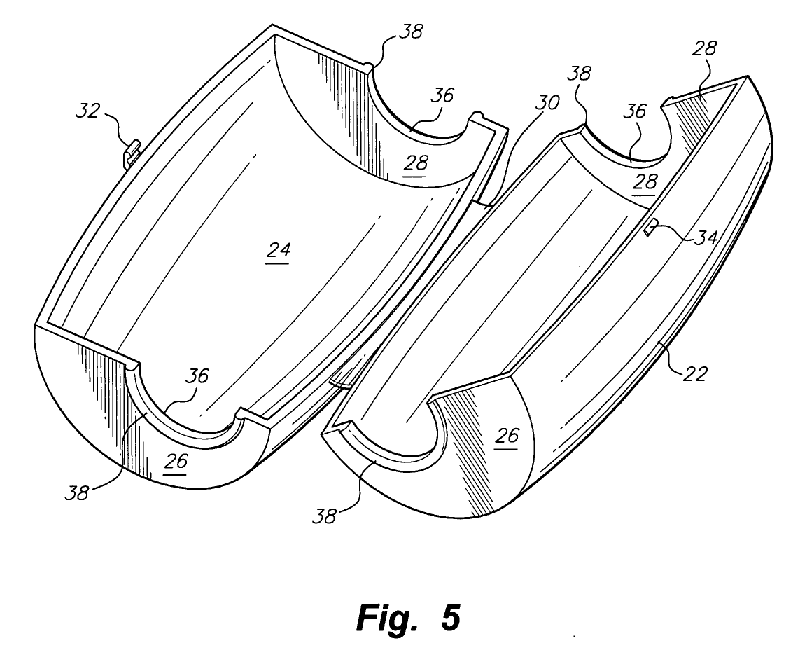

Referring now to FIGS. 2A-6, the present invention will be described. The protective housing 20 includes a first housing element 22 and a second housing element 24. First housing element 22 and second housing element 24 are coupled together by a hinge 30, which preferably is formed as a living hinge. In this arrangement, the first housing element 22, second housing element 24 and hinge 30 are formed as one piece, in accordance with any conventional manufacturing technique, such as a two cavity injection mold into which a stable, durable and lightweight material (e.g., plastic, PVC, or the like) is injected.

First housing element 22 includes opposing end walls 26 and 28. Likewise, second housing element 24 includes opposing end walls 26 and 28. Each of opposing end walls 26 and 28 include a semi-circular cutout 36, having a thickened or rounded edge 38, which will be discussed hereafter. The first housing element 22 and second housing element 24 cooperate to form an interior chamber when closed. The interior chamber is adapted to enclose a portion of the fishing rod 10, line 18, and the entire lure and hook assembly 14 therein. When closed, the fishing rod 10 and line 12 extend through the protective housing 20, thus providing a simple and secure cover over the otherwise exposed barbs of the lure 14.

The thickened or rounded edge 38 of the semi-circular cutouts 36 provides a surface upon which the fishing line 18 may engage without the possibility of damage due to kinking or nicking the line 18 resulting in a weakened line susceptible to breakage. The semi-circular cutouts 36, along with the thickened or rounded edge 38 form the circular apertures in each end wall of the closed protective housing 20.

The hinge 30 is formed or configured so that it provides a stable pivoting connection in order to facilitate single hand operation. The hinge 30 may be formed as a unitary member along substantially the entire length of the protective housing 20, as shown, or the hinge 30 may be one or more elements, so long as during the closing of the first and second housing elements 22, 24 the respective edges thereof automatically align, thereby increasing the single handed operation of the protective housing 20. Furthermore, any type of hinge may be used to connect the first and second housing elements. The protective housing 20 may be formed of any dimensions deemed suitable.

To further facilitate single handed operation, the first and second housing elements 22, 24 have cooperating latch members 32, 34 that maintain the protective housing 20 in the closed position. Latch members 32, 34 are also formed during the molding process of the protective housing 20. The latch members 32, 34 are formed either internally or externally of the protective housing 20. In either arrangement, single handed operation is further enabled because the release of the latch members 32, 34 is accomplished by applying pressure to one of the housing elements 22, 24 so as to cause the respective latch member 32, 34 to release, thereby opening the protective housing 20. It is noted that FIG. 2B illustrates an alternate arrangement of the latch members 32, 34 which facilitates either an internally or externally disposed latch. Either arrangement provides the user the ability to open or close the protective housing 20 with one hand.

The cover 20 provides a safe, secure, and inexpensive protective housing 20 that completely covers the lure 14 when not used for fishing, in particular during transport, such that the potential for the lure 14 to become entangled with other fishing lines or snagged on clothing or upholstery has been eliminated.

While there is shown and described herein certain specific aspects embodying the invention, it will be manifest to those skilled in the art that various modifications and rearrangements of the parts may be made without departing from the spirit and scope of the underlying inventive concept. For example, while the protective housing is disclosed as being formed of a plastic material, any suitable material which may be used to form the housing, such as carbon fiber, fiberglass or metal materials may be used to form the protective housing. In addition, the shape may have any suitable form so as to facilitate a single-handed operation for both closing and opening the protective housing.

It will be noted that the cutouts 36 in end walls 26 and 28 are not aligned through the center of end walls 26 and 28, but are eccentrically formed in the end walls 26 and 28. It will be noted in FIG. 1 that the lure 14 extends to only one side of the pole 10. By forming the through holes in the end walls 26 and 28 in eccentric manner, the volume of the cover 20 is the minimum necessary to enclose the lure and fish hook assembly 14, thereby conserving material.

It is to be understood that the present invention is not limited to the embodiment described above, but encompasses any and all embodiments within the scope of the following claims.

1. A protective housing in combination with a lure, a fishing line, and a fishing rod, consisting essentially of:
a first housing element having a substantially semi-cylindrical shape, and first and second opposing end walls, the end walls each having a semi-circular cutout defined therein;
a second housing element having a substantially semi-cylindrical shape, and first and second opposing end walls each end wall having a semi-circular cutout defined therein;
wherein each of the semi-circular cutouts has a thickened, rounded edge;
a hinge coupling the first and second housing elements together, whereby the first and second housing elements define an interior chamber when in a closed position, the semi-circular cutouts forming aligned circular apertures in the opposing end walls, when in said closed position;
wherein each of the circular apertures are eccentrically defined in the end walls; and
a latching device for releasably maintaining the first and second housing elements in the closed position;
whereby the first and second housing elements are wrapped around a portion of the fishing rod, and a portion of the fishing line, and secured thereto, the interior chamber enclosing the lure, the portion of the line and the portion of the fishing rod therein, and said thickened, rounded edges preventing a kinking of the fishing line on the fishing rod when said first and second housing elements are in the closed position around the fishing line, fishing rod, and lure.

2. (Canceled)

3. The protective housing according to claim 1, wherein the circular apertures are in registry.

4. (Canceled)

5. A cover for a fishing lure attached to a fishing line on a fishing rod, consisting essentially of:
a first housing element having a substantially semi-cylindrical shape, and first and second opposing end walls;
a second housing element having a substantially semi-cylindrical shape, and first and second opposing end walls;
each of the first and second end walls of the first and second housing elements having a semi-circular cutout defined therein, each said semi-circular cutout having a thickened, rounded edge;
the first housing element and the second housing element being hingedly coupled so as to form a substantially cylindrical chamber having substantially circular end walls;
wherein the each of the semi-circular cutouts has a thickened, rounded edge; and
a latching device for releasably latching the hingedly coupled housing elements in a closed position;
wherein the respective cutouts cooperating so as to form circular apertures in the respective circular end walls, said thickened, rounded edges preventing kinking of the fishing line on the fishing rod when the cover is in the closed position around the rod and lure.

6. The cover according to claim 5, wherein the each of the circular apertures are eccentric with the respective circular end.

7. The cover according to claim 6, wherein the circular apertures are concentric.

8. (Canceled)
